(19) United States
(12) Patent Application Publication
(10) Pub. No.: US 2020/0320616 A1
(43) Pub. Date: Oct. 8, 2020

(54) SYSTEMS AND METHODS FOR PROACTIVELY RECOGNIZING REASONS FOR ACCOUNT ENGAGEMENT AND PROVIDING NOTIFICATIONS

(71) Applicant: CAPITAL ONE SERVICES, LLC, McLean, VA (US)

(72) Inventors: Joshua EDWARDS, Philadelphia, PA (US); Michael MOSSOBA, Arlington, VA (US); Abdelkader BENKREIRA, Washington, DC (US)

(73) Assignee: CAPITAL ONE SERVICES, LLC, McLean, VA (US)

(21) Appl. No.: 16/375,793

(22) Filed: Apr. 4, 2019

(51) Int. Cl. G06Q 40/02; G06N 20/10; G06N 20/20

(52) U.S. Cl. CPC G06Q 40/02; G06N 20/20; G06N 20/10

(57) ABSTRACT

Systems and methods for monitoring accounts are disclosed. For example, a system may include one or more memory units storing instructions and one or more processors configured to execute the instructions to perform operations. The operations may include receiving account data and account-engagement data associated with an account. The account engagement data may include data related to actions a user performs on a user device, the actions being associated with the account. The operations may include training a user event-model based on a relationship between the account data and account-engagement data. The operations may include receiving additional account data associated with the account and identifying, using the user event-model, a triggering event instance based on the additional account data. The operations may include transmitting a notification based on the triggering event instance.

### BACKGROUND

Many account holders or users of various accounts wish to remain informed when some account events occur but not for all account events. For example, a financial account user may wish to know a large transaction posts but not when small transactions post; an email account holder may wish to know when an important email is received but not when unimportant email is received; a healthcare-provider account holder may wish to know when a test result arrives; a utility account holder may wish to know when usage exceeds a threshold value, etc.

Some conventional account systems monitor accounts to provide notifications for certain account events. Conventional systems and methods for providing account notifications typically consist of default notifications or notifications based on user-configured logical rules. However, conventional approaches are often limited in their ability to customize notifications to the particularized needs of users, who may receive unwanted notifications, may fail to receive notifications about account events of interest, and/or may be unable to accurately anticipate future needs and pre-configure logical rules.

Consequently, users may need to engage accounts (e.g., via an app on a user device) to receive information related to the event of interest. Conventional systems often do not use these account-engagement data to proactively provide notifications related to account events of interest so that users may avoid engaging accounts. This leads to inefficient consumption of resources (e.g., bandwidth, data usage, processing power, etc.).

In addition, conventional approaches often base notifications on the account activity (e.g., whether a transaction posted) but not on a user's availability or preferences (e.g., whether a user is at home or at work). As a result, notifications may arrive at an inconvenient or inappropriate time or place. This may also lead to inefficient usage of resources through unnecessary account engagement

Therefore, in view of the shortcomings and problems with conventional approaches to providing account notifications, there is a need for unconventional approaches to account monitoring and providing account notifications that anticipate a user's needs or interests based on account data, activity data, and/or account-engagement data.

### SUMMARY

The disclosed embodiments provide unconventional methods and systems for monitoring accounts. As compared to conventional solutions, the embodiments include using event models to identify triggering events based on account data, account-engagement data, activity data, and user profile data.

Consistent with the present embodiments, a system for monitoring accounts is disclosed. The system may include one or more memory units storing instructions and one or more processors configured to execute the instructions to perform operations. The operations may include receiving account data associated with an account and receiving account-engagement data associated with the account. The account-engagement data may include data related to actions a user performs on a user device, the actions being associated with the account. The operations may include training a user event-model to identify a triggering event based on a relationship between the account data and account-engagement data. The operations may include receiving additional account data associated with the account and identifying, using the user event-model, a triggering event instance based on the additional account data. The operations may include transmitting a notification based on the triggering event instance.

Consistent with the present embodiments, a method for monitoring accounts is disclosed. The method may include receiving account data associated with an account and receiving account-engagement data associated with the account. The account-engagement data may include data related to actions a user performs on a user device, the actions being associated with the account. The method may include training a user event-model to identify a triggering event based on a relationship between the account data and account-engagement data. The method may include receiving additional account data associated with the account and identifying, using the user event-model, a triggering event instance based on the additional account data. The method may include transmitting a notification based on the triggering event instance.

Consistent with other disclosed embodiments, non-transitory computer readable storage media may store program instructions, which are executed by at least one processor device and perform any of the methods described herein.

The disclosed systems and methods may be implemented using a combination of conventional hardware and software as well as specialized hardware and software, such as a machine constructed and/or programmed specifically for performing functions associated with the disclosed method steps. The foregoing general description and the following detailed description are exemplary and explanatory only and are not restrictive of the claims.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 depicts an exemplary system for monitoring accounts, consistent with disclosed embodiments.

FIG. 2 depicts an exemplary monitoring system, consistent with disclosed embodiments.

FIG. 3 depicts an exemplary user device, consistent with disclosed embodiments.

FIG. 4 depicts an exemplary process for training a reference event-model based on a plurality of accounts, consistent with disclosed embodiments.

FIG. 5 depicts an exemplary process for training a user event-model based on an account, consistent with disclosed embodiments.

FIG. 6 depicts an exemplary process to monitor an account, consistent with disclosed embodiments.

FIG. 7 depicts an exemplary process for engaging an account monitoring system, consistent with disclosed embodiments.

### DESCRIPTION OF THE EMBODIMENTS

Consistent with disclosed embodiments, systems and methods to monitor accounts are disclosed. Advantageously, embodiments include methods to proactively identify a triggering event and transmit a notification based on the triggering event, wherein identification and/or the transmitting may be based on account-engagement data (e.g., app views of account data). For example, based on previous account-engagement data, systems and methods may determine that an account event (e.g., a large deposit) is of interest to a user when the user is at a residence but not when the user is at a place of business. The system may recognize and identify the account event and transmit the notification when the system receives user-activity data that includes location data indicating a user-device may be located at a residence. As one of skill in the art will appreciate, other examples of triggering events and notifications and are possible.

Embodiments consistent with the present disclosure may include account data. The account data may be associated with a user (i.e., user-account data) and/or more than one user. In some embodiments, an account may include a user account, a financial account (e.g., a credit card or bank), an insurance account, a healthcare-provider account, a utility account (e.g., a telephone, mobile phone, gas, electric, or water account), a user account, a service account (e.g., an automobile service account), a merchant account (e.g., an online store account), an email account, a messaging-service account, a social media account, a membership account, an educational account, and/or any other account. Account data may include transaction data (e.g., payment data, charge data, and/or deposit data), healthcare data, service data, upload data, download data, file size data, message data, view data, cross-reference data, social media data, purchase data, educational data, utility data, electricity data, water data, call data, Short Message Service (SMS) data, email data, and/or other data. Account data may include data related to an account status (e.g., a classification of the account, a balance, a number of messages, data used, a length of time an account has been active, etc.).

Embodiments consistent with the present disclosure may include account-engagement data. Account-engagement data may be related to a user and/or an account. Account-engagement data may be related to a user device, including actions a user performs on a user device. For example, actions a user performs on a user device may include opening an app or webpage, viewing an app or webpage, providing input data, navigating a menu (e.g., a website menu, an app menu, an Interactive Voice Response menu, or the like), selecting a prompt, selecting a menu-option, and/or other actions. Account-engagement data may include data related to an account action. An account action may include requesting information about an account status (e.g., checking a balance), sending a message, scheduling an appointment, scheduling a transaction, and/or other account event. Account-engagement data may include location data, call data, screen time data, query data, refresh data, login data, an identifier, a phone number, an IP address, location data, time data, user-satisfaction data, and/or other data related to an account action or an action on a user device. Account-engagement may be related to a call, a chat session, or an email to or from an account system (e.g., a call to a customer service system).

Embodiments consistent with the present disclosure may include activity data. Activity data may include location data, purchase data, order data, reservation data, search term data, website visit data, media data, download data, upload data, social media data, message data, call data, cookie data, viewing history data (e.g., online video streaming activity), shopping history data, transaction data, internet search data, or other activity data. Activity data may be associated with a user (e.g., user-activity data), more than one user, an account, one or more user devices, and/or more than one account. Activity-data may include data related to activities other than account engagement through an application or other contact with an account provider.

Embodiments consistent with the present disclosure may include user profile data. The user profile data may include an account rule to classify an account event based on an event condition. The event condition may be based on account data (e.g., a threshold transaction amount, a threshold number of messages received, account data associated with a location, etc.). In some embodiments, the account rule includes a rule to classify an account event as a triggering event (i.e., an event that triggers a notification). User profile data may include data related to a user (e.g., an identifier, a sex, a birth date, a classification). For example, user profile data may include a data-management permissions level.

Embodiments consistent with the present disclosure may include a notification trigger. In some embodiments, a notification trigger may be a logical expression that specifies whether to transmit a notification based on a condition. For example, a condition may include a transmitting a notification when activity-data and/or account-engagement data satisfy a criterion (e.g., at a specified time, following a login, and/or when a user device is near a location). In some embodiments, the notification trigger may be a machine learning model that produces a non-deterministic response indicating whether to transmit a notification. In some embodiments, the notification trigger includes a combination of a logical expression and a machine learning model.

Reference will now be made in detail to exemplary embodiments, examples of which are illustrated in the accompanying drawings and disclosed herein. Wherever convenient, the same reference numbers will be used throughout the drawings to refer to the same or like parts. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

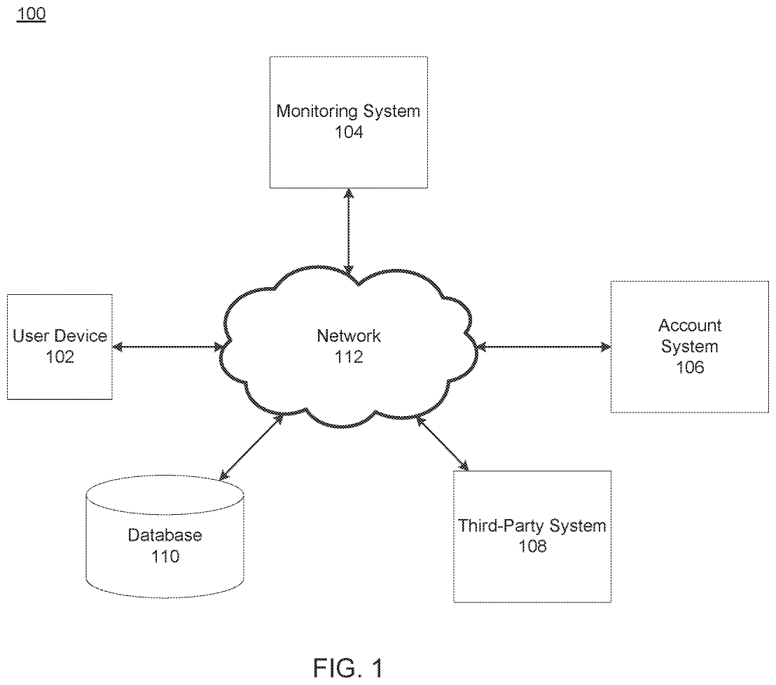

FIG. 1 depicts exemplary system 100 for monitoring accounts, consistent with disclosed embodiments. As shown, system 100 may include a user device 102, a monitoring system 104, an account system 106, a third-party system 108, and a database 110. Components of system 100 may be connected to each other through a network 112.

In some embodiments, aspects of system 100 may be implemented on one or more cloud services designed to generate (“spin-up”) one or more ephemeral container instances in response to event triggers, assign one or more tasks to a container instance, and terminate (“spin-down”) a container instance upon completion of a task. By implementing methods using cloud services, disclosed systems may efficiently provision resources based on demand and provide security advantages because the ephemeral container instances may be closed and destroyed upon completion of a task. That is, the container instances do not permit access from outside using terminals or remote shell tools like SSH, RTP, FTP, or CURL, for example. Further, terminating container instances may include destroying data, thereby protecting sensitive data. Destroying data can provide security advantages because it may involve permanently deleting data (e.g., overwriting data) and associated file pointers.

As will be appreciated by one skilled in the art, the components of system 100 can be arranged in various ways and implemented with any suitable combination of hardware, firmware, and/or software, as applicable. For example, as compared to the depiction in FIG. 1, system 100 may include a larger or smaller number of user devices, monitoring systems, account systems, third-party systems, databases, speech-recognition systems, and/or networks. In addition, system 100 may further include other components or devices not depicted that perform or assist in the performance of one or more processes, consistent with the disclosed embodiments. The exemplary components and arrangements shown in FIG. 1 are not intended to limit the disclosed embodiments.

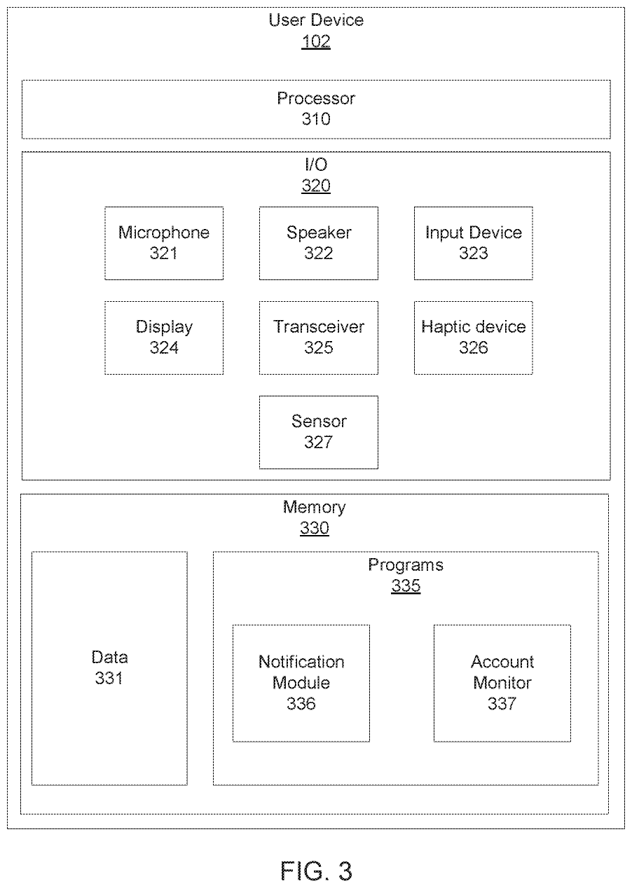

User device 102 may include one or more memory units and one or more processors configured to perform operations consistent with disclosed embodiments. In some embodiments, user device 102 may include hardware, software, and/or firmware modules. User device 102 may be a mobile device, a tablet, a personal computer, a terminal, a kiosk, a server, a server cluster, a cloud service, a storage device, a specialized device configured to perform methods according to disclosed embodiments, or the like. User device 102 is disclosed in greater detail below (in reference to FIG. 3).

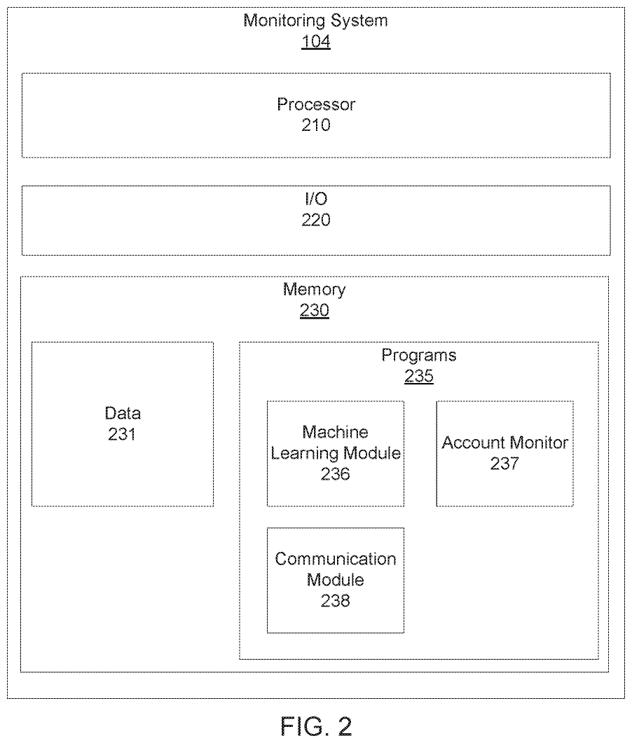

Monitoring system 104 may include a computing device, a computer, a server, a server cluster, a plurality of clusters, and/or a cloud service, consistent with disclosed embodiments. Monitoring system 104 may include one or more memory units and one or more processors configured to perform operations consistent with disclosed embodiments. Monitoring system 104 may include computing systems configured to generate, receive, retrieve, store, and/or provide monitoring data, consistent with disclosed embodiments. Monitoring system 104 may include computing systems configured to generate and train models, consistent with disclosed embodiments. Monitoring system 104 may be configured to receive data from, retrieve data from, and/or transmit data to other components of system 100 and/or computing components outside system 100 (e.g., via network 112). In some embodiments, not shown, monitoring system 104 is a component of account system 106. Monitoring system 104 is disclosed in greater detail below (in reference to FIG. 2).

Account system 106 may include one or more memory units and one or more processors configured to perform operations consistent with disclosed embodiments. Account system 106 may include a computing device, a computer, a server, a server cluster, a plurality of clusters, and/or a cloud service, consistent with disclosed embodiments. Account system 106 may be configured to generate and train models, consistent with disclosed embodiments. Account system 106 may be configured to receive data from, retrieve data from, and/or transmit data to other components of system 100 and/or computing components outside system 100 (e.g., via network 112). In some embodiments not shown, account system 106 may be a component of monitoring system 104.

Account system 106 may be configured to manage data (e.g., monitor, analyze, store, and/or provide data), consistent with disclosed embodiments. The data may include account data, account-engagement data, user profile data, activity data, event model data (e.g., model parameters, training criteria, performance metrics, etc.), and/or other data.

Account system 106 may be configured to route signals, consistent with disclosed embodiments. For example, account system 106 may be configured to route call signals, internet connection signals, and/or other signals. As an example, account system 106 may be configured to route a call to a department and/or to route a website visitor to an internet page. In some embodiments, account system 106 may be configured to transmit messages and/or place calls. For example, account system 106 may be configured to provide notifications (e.g., push notifications).

Account system 106 may be configured to conduct an authentication process, consistent with disclosed embodiments. In some embodiments, an authentication process includes transmitting a request to provide a password, a pin, a token, an answer to a secret question, a code, a biometric input, or other authentication data. In some embodiments, an authentication process includes receiving a password, a pin, an answer to a secret question, a code, a biometric input, a token, or other authentication data. In some embodiments, an authentication includes a Completely Automated Public Turing Test to tell Computers and Humans Apart (CAPTCHA) process. In some embodiments, an authentication process includes a multi-factor authentication. In some embodiments, the authentication process may be tokenized.

Third-party system 108 may be configured to manage activity data (e.g., monitor, analyze, store, and/or provide activity data) associated with a user or an account, consistent with disclosed embodiments. Third-party system 108 may include one or more memory units and one or more processors configured to perform operations consistent with disclosed embodiments. Third-party system 108 may include a computing device, a computer, a server, a server cluster, a plurality of clusters, and/or a cloud service, consistent with disclosed embodiments. Third-party system 108 may be configured to receive data from, retrieve data from, and/or transmit data to other components of system 100 and/or computing components outside system 100 (e.g., via network 112). In some embodiments, activity data of third-party system 108 includes activity data as previously described and/or other activity data. In some embodiments, third-party system 108 includes a social media system.

Database 110 may include one or more databases configured to store data for use by system 100, consistent with disclosed embodiments. Database 110 may include a cloud-based database (e.g., AMAZON WEB SERVICES RELATIONAL DATABASE SERVICE) or an on-premises database. Database 110 may include account data, account-engagement data, user profile data, activity data, event model data (e.g., model parameters, training criteria, performance metrics, etc.) and/or other data, consistent with disclosed embodiments. Database 110 may include data received from one or more components of system 100 and/or computing components outside system 100 (e.g., via network 112).

At least one of user device 102, monitoring system 104, account system 106, third-party system 108, and database 110 may connect to network 112. Network 112 may be a public network or private network and may include, for example, a wired or wireless network, including, without limitation, a Local Area Network, a Wide Area Network, a Metropolitan Area Network, an IEEE 1002.11 wireless network (e.g., “Wi-Fi”), a network of networks (e.g., the Internet), a land-line telephone network, or the like. Network 112 may be connected to other networks (not depicted in FIG. 1) to connect the various system components to each other and/or to external systems or devices. In some embodiments, network 112 may be a secure network and require a password to access the network.

FIG. 2 depicts exemplary monitoring system 104, consistent with disclosed embodiments. Monitoring system 104 may include a computing device, a computer, a server, a server cluster, a plurality of clusters, and/or a cloud service, consistent with disclosed embodiments. As shown, monitoring system 104 may include one or more processors 210, one or more I/O devices 220, and one or more memory units 230. In some embodiments, some or all components of monitoring system 104 may be hosted on a device, a computer, a server, a cluster of servers, or a cloud service. In some embodiments, monitoring system 104 may be a scalable system configured to efficiently manage resources and enhance security by provisioning computing resources in response to triggering events and terminating resources after completing a task (e.g., a scalable cloud service that spins up and terminates container instances).

FIG. 2 depicts an exemplary configuration of monitoring system 104. As will be appreciated by one skilled in the art, the components and arrangement of components included in monitoring system 104 may vary. For example, as compared to the depiction in FIG. 2, monitoring system 104 may include a larger or smaller number of processors, I/O devices, or memory units. In addition, monitoring system 104 may further include other components or devices not depicted that perform or assist in the performance of one or more processes consistent with the disclosed embodiments. The components and arrangements shown in FIG. 2 are not intended to limit the disclosed embodiments, as the components used to implement the disclosed processes and features may vary.

Processor 210 may comprise known computing processors, including a microprocessor. Processor 210 may constitute a single-core or multiple-core processor that executes parallel processes simultaneously. For example, processor 210 may be a single-core processor configured with virtual processing technologies. In some embodiments, processor 210 may use logical processors to simultaneously execute and control multiple processes. Processor 210 may implement virtual machine technologies, or other known technologies to provide the ability to execute, control, run, manipulate, store, etc., multiple software processes, applications, programs, etc. In another embodiment, processor 210 may include a multiple-core processor arrangement (e.g., dual core, quad core, etc.) configured to provide parallel processing functionalities to allow execution of multiple processes simultaneously. One of ordinary skill in the art would understand that other types of processor arrangements could be implemented that provide for the capabilities disclosed herein. The disclosed embodiments are not limited to any type of processor(s) 210. Processor 210 may execute various instructions stored in memory 230 to perform various functions of the disclosed embodiments described in greater detail below. Processor 210 is configured to execute functions written in one or more known programming languages.

I/O devices 220 may include at least one of a display, an LED, a router, a touchscreen, a keyboard, a microphone, a speaker, a haptic device, a camera, a button, a dial, a switch, a knob, a transceiver, an input device, an output device, or another I/O device to perform methods of the disclosed embodiments. I/O devices 220 may be components of an interface of account system 106.

Memory 230 may be a volatile or non-volatile, magnetic, semiconductor, optical, removable, non-removable, or other type of storage device or tangible (i.e., non-transitory) computer-readable medium, consistent with disclosed embodiments. As shown, memory 230 may include data 231, including one of at least one of encrypted data or unencrypted data. Consistent with disclosed embodiments, data 231 may include account data, account-engagement data, user profile data, activity data, event model data (e.g., model parameters, training criteria, performance metrics, etc.) and/or other data.

Programs 235 may include one or more programs (e.g., modules, code, scripts, or functions) used to perform methods consistent with disclosed embodiments. Programs may include operating systems (not shown) that perform known operating system functions when executed by one or more processors. Disclosed embodiments may operate and function with computer systems running any type of operating system. Programs 235 may be written in one or more programming or scripting languages. One or more of such software sections or modules of memory 230 may be integrated into a computer system, non-transitory computer-readable media, or existing communications software. Programs 235 may also be implemented or replicated as firmware or circuit logic.

Programs 235 may include a machine-learning module 236, an account monitor 237, and a communication module 238 and/or other modules not depicted to perform methods of the disclosed embodiments. In some embodiments, modules of programs 235 may be configured to generate (“spin up”) one or more ephemeral container instances to perform a task and/or to assign a task to a running (warm) container instance, consistent with disclosed embodiments. Modules of programs 235 may be configured to receive, retrieve, and/or generate models, consistent with disclosed embodiments. Modules of programs 235 may be configured to perform operations in coordination with one another. In some embodiments, programs 235 may be configured to conduct an authentication process, consistent with disclosed embodiments.

Machine-learning module 236 may include programs (scripts, functions, algorithms) to train, implement, store, receive, retrieve, and/or transmit one or more machine-learning models. The machine-learning models may include a neural network model, a recurrent neural network (RNN) model, a deep learning model, a random forest model, a convolutional neural network (CNN) model, a support vector machine model and/or another machine-learning model. Models may include an ensemble model (i.e., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. Machine-learning module 236 may be configured to adjust model parameters during training. Model parameters may include weights, coefficients, offsets, or the like. Training may be supervised or unsupervised.

Account monitor 237 may include programs (scripts, functions, algorithms) to receive data from, retrieve data from, and/or transmit data to other components of system 100 and/or computing components outside system 100. For example, account monitor 237 may be configured to receive data from user device 102, account system 106, and/or third-party system 108. The data may include account data, account-engagement data, user profile data, activity data, event model data (e.g., model parameters, training criteria, performance metrics, etc.), and/or other data. consistent with disclosed embodiments. For example, account monitor 237 may be configured to receive a request and retrieve account data from account system 106 based on the request. Account monitor 237 may be configured to send a request to third-party system 108 and receive activity data in response to the request.

In some embodiments, account monitor 237 may be configured to identify a triggering event and/or a particular instance of a triggering event (i.e., a triggering event instance) based on account data, account-engagement data, activity data, and/or user profile data, consistent with disclosed embodiments. In some embodiments, identifying a triggering event and/or triggering event instance may be based on one or more relationships between account data, account-engagement data, and/or activity data. The relationship may include a correlation, a regression, or any other statistical relationship. In some embodiments, classifying an account event may be based on a rule (e.g., an account rule, as previously described). In some embodiments, account monitor 237 may be configured to determine a notification history. For example, account monitor 237 may determine whether a previous notification has been provided based on a triggering event.

In some embodiments, account monitor 237 may be configured to generate and train an event model to identify triggering events. The event model may be a reference event-model trained using reference data associated with a plurality of accounts and/or users (i.e., reference account-engagement data, reference account-data, and/or reference activity-data). The event model may be a user event-model trained using user data associated with a user and/or account (i.e., user account-engagement data, user account-data, and/or user activity-data). The event model may be trained to generate a logical expression that specifies whether to transmit a notification based on a notification trigger (i.e., based on a condition). In some embodiments, an event-model may produce a non-deterministic response to data, the response specifying whether to transmit a notification. In some embodiments, the event model may include a logical expression and a model that produces a non-deterministic response.

Communication module 238 may include protocols and communication standards to open and maintain connections to other components of system 100 (e.g., via network 112) and/or to computing components outside system 100. Communication module 238 may include functions to connect to a cellular data network, a Wi-Fi network, a Bluetooth device, a Li-Fi network, an optical wireless network, a Near Field Communication (NFC) network, or other wireless connection. In some embodiments, communication module 238 may include functions to connect to a device using at least one of a Universal Serial Bus (USB) connection, a Firewire connection, an ethernet connection, or another cable connection. Communication module 238 may include programs and scripts to connect with, for example, network 112 and/or user device 102 (e.g., via Bluetooth, Li-Fi, Wi-Fi, NFC, or the like). Communication module 238 may be configured to send and receive data via a network, such as network 112, and may be configured to send and receive data to other modules of monitoring system 104. In some embodiments, communication module 238 is configured to transmit a notification.

FIG. 3 depicts exemplary user device 102, consistent with disclosed embodiments. User device 102 may be a phone, a mobile device, a tablet, a personal computer, a server, a server cluster, a specialized device configured to perform methods according to disclosed embodiments, or the any other user device.

User device 102 may include one or more processors 310, input/output units (I/O devices) 320, and one or more memory units 330. FIG. 3 is an exemplary configuration of user device 102. As will be appreciated by one skilled in the art, the components and arrangement of components included in user device 102 may vary. For example, as compared to the depiction in FIG. 3, user device 102 may include a larger or smaller number of processors, I/O devices, or memory units. In addition, user device 102 may further include other components or devices not depicted that perform or assist in the performance of one or more processes consistent with the disclosed embodiments. The components and arrangements shown in FIG. 3 are not intended to limit the disclosed embodiments, as the components used to implement the disclosed processes and features may vary.

Processor 310 may include known computing processors, including a microprocessor. Processor 310 may include a single-core or multiple-core processor that executes parallel processes simultaneously. For example, processor 310 may include a single-core processor configured with virtual processing technologies. In some embodiments, processor 310 may use logical processors to simultaneously execute and control multiple processes. Processor 310 may implement virtual machine technologies, or other known technologies to provide the ability to execute, control, run, manipulate, store, etc., multiple software processes, applications, programs, etc. In another embodiment, processor 310 may include a multiple-core processor arrangement (e.g., dual core, quad core, etc.) configured to provide parallel processing functionalities to allow execution of multiple processes simultaneously. One of ordinary skill in the art would understand that other types of processor arrangements may be implemented that provide for the capabilities disclosed herein. The disclosed embodiments are not limited to any type of processor(s) 310. Processor 310 may execute various instructions stored in memory 330 to perform various functions of the disclosed embodiments described in greater detail below. Processor 310 may be configured to execute functions written in one or more known programming languages.

Referring again to FIG. 3, I/O devices 320 may include components of an interface, such as a user interface. I/O devices 320 may include a microphone 321, a speaker 322, an input device 323, a display 324, a transceiver 325, haptic device 326, and/or sensor 327. I/O devices 320 may include other I/O devices, not depicted, that perform or assist in the performance of one or more processes consistent with disclosed embodiments. In some embodiments, some or all of I/O devices 320 may be mounted to user device 102. In some embodiments, some or all of I/O devices 320 may be components of stand-alone devices communicatively coupled to user device 102.

Microphone 321 may be configured to receive an audio signal. In some embodiments, microphone 321 may include a microphone array. Microphone 321 may be mounted to user device 102 or may be communicatively coupled to user device 102 (e.g., a wired headset, wireless microphone, or the like).

Speaker 322 may include components configured to provide audio output. In some embodiments, speaker 322 may include an array of speakers.

Input device 323 may include at least one of a touchpad, a touch screen, a keyboard, a mouse, a track pad, a button, a dial, a knob, a switch, a location sensor, a biometric input device, or the any other input device. As will be appreciated by one of skill in the art, input device 323 may include any device capable of receiving inputs to perform or assist in performing methods consistent with disclosed embodiments.

Display 324 may include a light-emitting component, such as a light emitting diode (LED) or other component capable of providing a visible signal to a user. In some embodiments, display 324 may include at least one of a monitor, an LCD display, an LED display, a touch screen, a lamp, a projector, or another visual display.

Transceiver 325 may include a transceiver configured to connect with at least one of any type of cellular data network, or at least one of a Wi-Fi transceiver, a Li-Fi transceiver, Near Field Communication (NFC) transceiver, a radio transceiver, an ultra-high frequency (UHF) transceiver, a Bluetooth transceiver, an infrared transceiver, or other wireless transceiver.

Haptic device 326 may be configured to provide haptic feedback. For example, haptic device 326 may include a device configured to vibrate (e.g., an eccentric rotating mass actuator and/or a linear resonant actuator), to provide force, or to induce a sense of touch without physical contact of a device (e.g., via an air vortex ring, ultrasound, etc.).

Sensor 327 may include, for example, a location sensor (e.g., a global positioning system (GPS) sensor, a magnetometer, or an altimeter), a camera, a light sensor, an audio sensor, or a motion sensor (e.g., a gyroscope, an accelerometer, a light-based motion detector).

Memory 330 may be a volatile or non-volatile, magnetic, semiconductor, optical, removable, non-removable, or other type of storage device or tangible (i.e., non-transitory) computer-readable medium, consistent with disclosed embodiments. As shown, memory 330 may include data 331, including of at least one of encrypted data or unencrypted data. Data 331 may include account data, account-engagement data, user profile data, activity data, event model data (e.g., model parameters, training criteria, performance metrics, etc.), and/or other data.

Programs 335 may include one or more programs (e.g., modules, code, scripts, or functions) used to perform methods consistent with disclosed embodiments. Programs may include operating systems (not shown) that perform known operating system functions when executed by one or more processors. Disclosed embodiments may operate and function with computer systems running any type of operating system. Programs 335 may be written in one or more programming or scripting languages. One or more of such software sections or modules of memory 330 may be integrated into a computer system, non-transitory computer-readable media, or existing communications software. Programs 335 may also be implemented or replicated as firmware or circuit logic.

As shown, programs 335 may include a notification module 336, an account monitor 337, and/or other modules not depicted to perform methods of the disclosed embodiments. Modules of programs 335 may be configured to perform operations in coordination with one another. In some embodiments, programs 335 may be configured to conduct an authentication process, consistent with disclosed embodiments.

Notification module 336 may be configured to receive and/or provide notification, consistent with disclosed embodiments. Receiving a notification may include receiving data from another component of system 100 and/or a computing component outside system 100. Providing a notification may include storing data, displaying data, playing data, and/or providing haptic feedback, consistent with disclosed embodiments. For example, providing a notification may include storing data in data 331, displaying data via display 324, playing an audio signal via speaker 322, and/or providing haptic feedback via haptic device 326. In some embodiments, the notification may include notification data (e.g., a statement), account data, account-engagement data, user profile data, activity data, event model data (e.g., model parameters, training criteria, performance metrics, etc.), and/or other data. In some embodiments, a notification may be a push notification (e.g., a notification received and/or provided when an application is not open on a device). In some embodiments, providing a notification includes transmitting a notification to a computing component of system 100 (e.g., account system 106) and/or to another computing component outside system 100 (e.g., a remote device).

Account monitor 337 may be configured to collect account-engagement data (e.g., receive, retrieve, and/or store account-engagement data), consistent with disclosed embodiments. For example, account monitor 337 may be configured to collect data related to actions a user performs on a user device (e.g., via I/O devices 320), consistent with disclosed embodiments. In some embodiments, account monitor 337 may be configured to collect data related to an account event (e.g., checking an account status, sending a message, scheduling an appointment, scheduling a transaction, or other account event). Account monitor 337 may be configured to collect an identifier, a phone number, an IP address, location data, time data, user-satisfaction data, and/or other data. Account monitor 337 may be configured to collect data related to a call (e.g., data related to a call to an automated system to obtain account data, customer service, etc.).

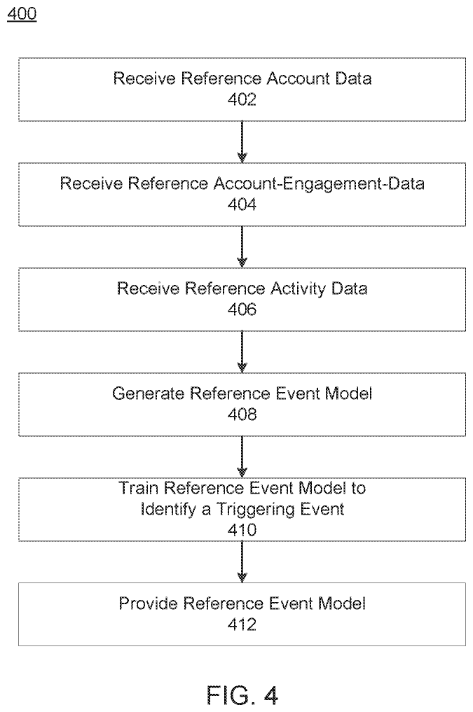

FIG. 4 depicts exemplary process 400 for training an event model based on a plurality of accounts, consistent with disclosed embodiments. In some embodiments, monitoring system 104 may perform one or more steps of process 400 using programs 235. One or more of machine-learning module 236, account monitor 237, communication module 238, and/or another module of programs 235 may perform operations of process 400, consistent with disclosed embodiments. In some embodiments, account system 106 may perform steps of process 400. In some embodiments, user device 102 may perform steps of process 400.

Consistent with disclosed embodiments, steps of process 400 may be performed on one or more cloud services using one or more ephemeral container instances. For example, at any of the steps of process 400, monitoring system 104 and/or account system 106 may generate (spin up) an ephemeral container instance to execute a task, assign a task to an already-running ephemeral container instance (warm container instance), or terminate a container instance upon completion of a task. As one of skill in the art will appreciate, steps of process 400 may be performed as part of an application interface (API) call. Process 400 may be performed according to a schedule and/or in response to a triggering event (e.g., an account event).

At step 402, monitoring system 104 may receive reference account-data, consistent with disclosed embodiments. Reference account-data may be associated with a plurality of accounts, consistent with disclosed embodiments. In some embodiments, step 402 may include retrieving or receiving reference account-data from account system 106, data 231, one or more user devices (e.g., user device 102), database 110, and/or a computing component outside system 100. Reference account-data at step 402 may be associated with one or more users. Reference account-data of step 502 may include any type of account data as previously described and/or other account data.

At step 404, monitoring system 104 may receive reference account-engagement data, consistent with disclosed embodiments. Reference account-engagement data may be associated with a plurality of accounts and/or users, consistent with disclosed embodiments. In some embodiments, step 404 may include retrieving or receiving reference account-engagement data from account system 106, data 231, one or more user devices (e.g., user device 102), database 110, and/or a computing component outside system 100. Reference account-engagement data of step 404 may include any account-engagement data as previously described and/or any other account-engagement data.

At step 406, monitoring system 104 may receive reference activity-data, consistent with disclosed embodiments. The reference activity-data may be associated with one or more users and/or accounts, consistent with disclosed embodiments. In some embodiments, step 406 includes retrieving or receiving reference activity-data from third-party system 108, data 231, one or more user devices (e.g., user device 102), database 110, and/or a computing component outside system 100. Reference activity-data of step 406 may include any type of activity data as previously described and/or other activity data.

At step 408, monitoring system 104 generates a reference event-model, consistent with disclosed embodiments. The reference event-model may be a machine-learning model. For example, the reference event-model may include a neural network model, a recurrent neural network model, a deep learning model, a random forest model, a convolutional neural network model, and/or another machine-learning model. Monitoring system 104 may generate a reference event-model based on a previously generated model. For example, Monitoring system 104 may receive or retrieve a model from a data storage (e.g., data 231 and/or database 110), another component of system 100, or a computing component outside system 100. In some embodiments, the generated model of step 408 may be a copy of a previously generated model.

Monitoring system 104 may generate a reference event-model at step 408 based on account data, activity data, and/or account-engagement data. For example, monitoring system 104 may determine a statistical metric and/or identify a data structure of account data, request data, activity data, and/or account-engagement data and generate a reference event-model based on the statistical metric or data structure. In some embodiments, the model type (e.g., RNN or other model type) may be based on an indication that a previous model of the type satisfied a performance criterion using similar account data, activity data, and/or account-engagement data. In some embodiments, monitoring system 104 may generate a plurality of models at step 408 configured to perform methods consistent with disclosed embodiment. In some embodiments, the reference event-model may be an ensemble model.

At step 410, monitoring system 104 may train a reference event-model to identify a triggering event (i.e., an event that triggers a notification) based on reference data (i.e., reference account-engagement data, reference account-data, and/or reference activity-data), consistent with disclosed embodiments. A reference event-model may be trained to identify a triggering event based on a relationship between reference account-engagement data, reference account-data, and/or reference activity-data, consistent with disclosed embodiments. In some embodiments, the relationship may include a correlation and/or other statistical relationship. For example, monitoring system 104 may train a reference event-model to identify a triggering event for an email account based on a relationship between the sender of an email and a time, a location of a user device and/or an opening of an app on a user device.

In some embodiments, training at step 410 may include training a reference event-model to generate a logical expression that specifies whether to transmit a notification based on a notification trigger (i.e., based on a condition). In some embodiments, the reference event-model may produce a non-deterministic response to reference data, the response specifying whether to transmit a notification. In some embodiments, reference event-model may include a logical expression and a model that produces a non-deterministic response.

As one of skill in the art will appreciate, a reference event-model of step 410 may include one or more models configured to perform disclosed methods (i.e., a reference event-model may be an ensemble model). In some embodiments, training at step 410 of one or more models may occur simultaneously with forward and backward propagation techniques. In some embodiments, training may be performed separately for separate models.

In some embodiments, training of a model terminates at step 410 when a training criterion is satisfied. Training criteria may include a number of epochs, a training time, a performance metric (e.g., a confidence level in identifying an account event), or the like. Step 410 may include adjusting model parameters during training. Model parameters may include weights, coefficients, offsets, or the like. Training at step 410 may be supervised or unsupervised.

At step 412, monitoring system 104 may provide a reference event-model, consistent with disclosed embodiments. Providing a model at step 412 may include storing the model (e.g., in data 231 and/or database 110), transmitting the model to a component of system 100, transmitting the model to a computing component outside system 100 (e.g., via network 112), and/or displaying the model (e.g., at display 324 of I/O 320).

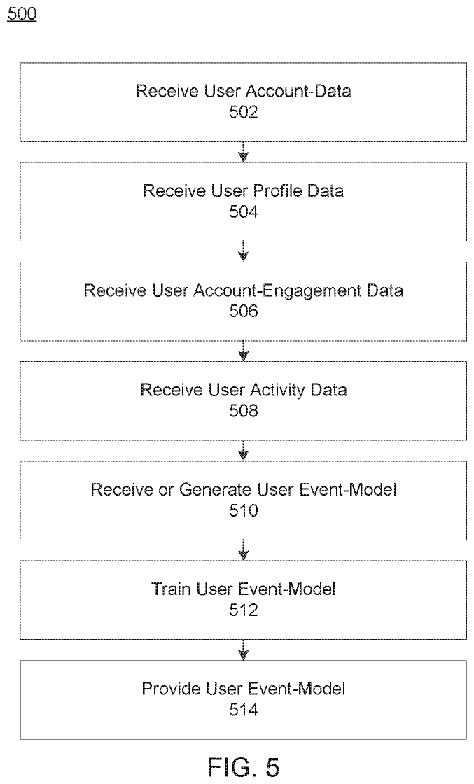

FIG. 5 depicts exemplary process 500 for training a user event-model based on an account, consistent with disclosed embodiments. In some embodiments, monitoring system 104 may perform one or more steps of process 500 using programs 235. One or more of machine-learning module 236, account monitor 237, communication module 238, and/or another module of programs 235 may perform operations of process 500, consistent with disclosed embodiments. In some embodiments, account system 106 may perform steps of process 500. In some embodiments, user device 102 may perform steps of process 500.

Consistent with disclosed embodiments, steps of process 500 may be performed on one or more cloud services using one or more ephemeral container instances. For example, at any of the steps of process 500, monitoring system 104 and/or account system 106 may generate (spin up) an ephemeral container instance to execute a task, assign a task to an already-running ephemeral container instance (warm container instance), or terminate a container instance upon completion of a task. As one of skill in the art will appreciate, steps of process 500 may be performed as part of an application interface (API) call. Process 500 may be performed according to a schedule and/or in response to a triggering event (e.g., an account event).

At step 502, monitoring system 104 may receive user account-data associated with an account and/or a user, consistent with disclosed embodiments. In some embodiments, user account-data may be associated with a user associated with a plurality of accounts, consistent with disclosed embodiments. In some embodiments, step 502 may include retrieving or receiving user account-data from account system 106, data 231, one or more user devices (e.g., user device 102), database 110, and/or a computing component outside system 100. User account-data of step 502 may include any type of account data as previously described and/or other account data.

At step 504, monitoring system 104 may receive user profile data associated with an account and/or a user, consistent with disclosed embodiments. For example, user profile data may include an account rule, as previously described.

At step 506, monitoring system 104 may receive user account-engagement data associated with an account and/or a user, consistent with disclosed embodiments. In some embodiments, step 504 may include retrieving or receiving user account-engagement data from account system 106, data 231, one or more user devices (e.g., user device 102), database 110, and/or a computing component outside system 100. User account-engagement data of step 504 may include any account-engagement data as previously described and/or any other account-engagement data.

At step 508, monitoring system 104 may receive user activity-data, consistent with disclosed embodiments. In some embodiments, step 508 may include retrieving or receiving activity data from third-party system 108, data 231, one or more user devices (e.g., user device 102), database 110, and/or a computing component outside system 100. User activity-data of step 506 may include any type of activity data as previously described and/or other activity data.

At step 510, monitoring system 104 may receive or generate a user event-model, consistent with disclosed embodiments. In some embodiments, the user event-model may be a model generated using steps of process 400 and step 510 may include receiving or retrieving a user event-model from a data 331, another component of system 100 and/or a computing component outside system 100. In some embodiments, step 510 may include implementing process 400 to generate and train a reference event-model. In some embodiments, generating a user event-model at step 510 may include copying a previously generated model.

At step 512, monitoring system 104 may train a user event-model to identify a triggering event (i.e., an event that triggers a notification) based on user data (i.e., user account-engagement data, user account-data, and/or user activity-data), consistent with disclosed embodiments. A user event-model may be trained to identify a triggering event based on a relationship between user account-engagement data, user account-data, and/or user activity-data, consistent with disclosed embodiments. In some embodiments, the relationship may include a correlation and/or other statistical relationship. For example, monitoring system 104 may train a user event-model to identify a triggering event for an email account based on a relationship between the sender of an email and a time, a location of a user device and/or an opening of an app on a user device.

In some embodiments, training at step 512 may include training a user event-model to generate a logical expression that specifies whether to transmit a notification based on a notification trigger (i.e., based on a condition). In some embodiments, the user event-model produces a non-deterministic response to user data, the response specifying whether to transmit a notification. In some embodiments, a user event-model may include a logical expression and a model that produces a non-deterministic response.

As one of skill in the art will appreciate, a user event-model of step 512 may include one or more models configured to perform disclosed methods (i.e., a user event-model may be an ensemble model). In some embodiments, training at step 512 of one or more models may occur simultaneously with forward and backward propagation techniques. In some embodiments, training may be performed separately for separate models.

In some embodiments, training of a model may terminate at step 512 when a training criterion is satisfied. Training criteria may include a number of epochs, a training time, a performance metric (e.g., a confidence level in identifying an account event), or the like. Step 512 may include adjusting model parameters during training. Model parameters may include weights, coefficients, offsets, or the like. Training at step 512 may be supervised or unsupervised.

At step 514, monitoring system 104 may provide the user event-model, consistent with disclosed embodiments. Providing a user event-model at step 514 may include storing the model (e.g., in data 231 and/or database 110), transmitting the model to a component of system 100, transmitting the model to a computing component outside system 100 (e.g., via network 112), and/or displaying the model (e.g., at display of I/O 220).

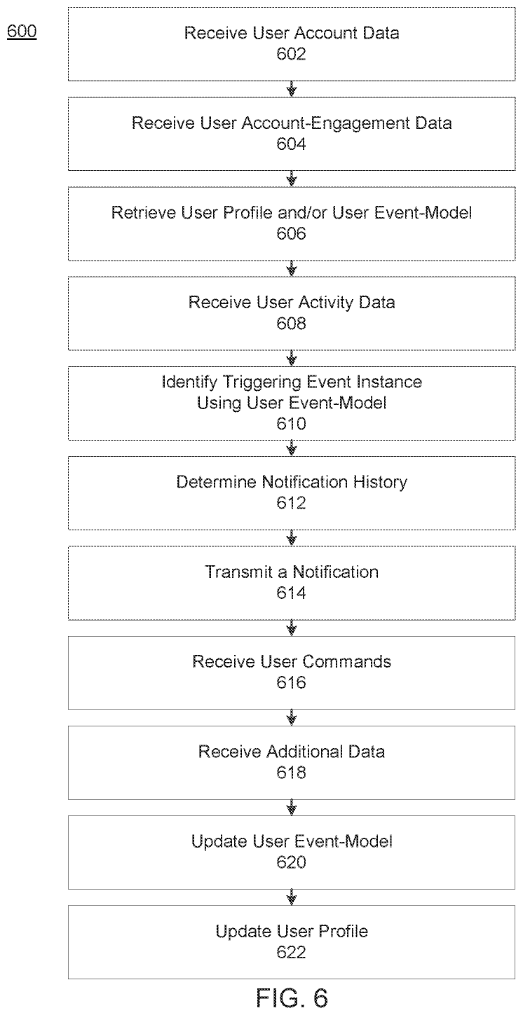

FIG. 6 depicts exemplary process 600 to monitor an account, consistent with disclosed embodiments. In some embodiments, monitoring system 104 may perform one or more steps of process 600 using programs 235. One or more of machine-learning module 236, account monitor 237, communication module 238, and/or another module of programs 235 may perform operations of process 600, consistent with disclosed embodiments. In some embodiments, account system 106 may perform steps of process 600. In some embodiments, user device 102 may perform steps of process 600.

Consistent with disclosed embodiments, steps of process 600 may be performed on one or more cloud services using one or more ephemeral container instances. For example, at any of the steps of process 600, monitoring system 104 and/or account system 106 may generate (spin up) an ephemeral container instance to execute a task, assign a task to an already-running ephemeral container instance (warm container instance), or terminate a container instance upon completion of a task. As one of skill in the art will appreciate, steps of process 600 may be performed as part of an application interface (API) call. Process 600 may be performed according to a schedule and/or in response to a triggering event (e.g., an account event).

At step 602, monitoring system 104 may receive user account-data, consistent with disclosed embodiments. User account data may be associated with an account and/or user, consistent with disclosed embodiments. In some embodiments, step 602 may include retrieving or receiving user account-data from account system 106, data 231, one or more user devices (e.g., user device 102), database 110, and/or a computing component outside system 100. User account data of step 602 may include any type of account data as previously described and/or other account data.

At step 604, monitoring system 104 may receive user account-engagement data, consistent with disclosed embodiments. User account-engagement data may be associated with an account and/or user, consistent with disclosed embodiments. Monitoring system 104 may receive user account-engagement data from account system 106, data 231, one or more user devices (e.g., user device 102), database 110, and/or a computing component outside system 100. User account-engagement data of step 604 may include any account-engagement data as previously described and/or any other account-engagement data.

At step 606, monitoring system 104 may retrieve user profile data and/or a user event-model, consistent with disclosed embodiments. In some embodiments, retrieving user profile data and/or a user event-model may include retrieving or receiving data from data 231, another component of system 100 and/or a computing component outside system 100. In some embodiments, user profile data of step 606 may include an account rule as previously described and/or any other account rule.

In some embodiments, a user event-model of step 606 may be a user event-model previously trained and/or generated (e.g., via process 400 or process 500). In some embodiments, step 606 may include implementing process 400 to generate and/or train a reference event-model. In some embodiments, step 606 may include implementing process 500 to generate and/or train a user event-model.

At step 608, monitoring system 104 may receive user activity-data, consistent with disclosed embodiments. In some embodiments, step 608 may include retrieving or receiving data from third-party system 108, data 231, one or more user devices (e.g., user device 102), database 110, and/or a computing component outside system 100. User activity-data of step 608 may include any type of activity data as previously described and/or other activity data.

At step 610, monitoring system 104 may identify a triggering event instance using the user event-model, consistent with disclosed embodiments. In some embodiments, identifying the triggering event instance may be based on the user data. In some embodiments, identifying the triggering event instance includes generating a notification condition (e.g., an instruction to provide a notification when user data satisfy a criterion).

At step 612, monitoring system 104 may determine a notification history based on the triggering event instance, consistent with disclosed embodiments. In some embodiments, monitoring system 104 may determine whether a previous notification has been transmitted based on the triggering event instance. In some embodiments, the notification history may be included in the account-engagement data and identifying the triggering event instance at step 610 may be based on the notification history.

At step 614, monitoring system 104 may transmit a notification based on the triggering event instance, consistent with disclosed embodiments. In some embodiments, transmitting a notification may include transmitting a notification to user device 102. In some embodiments, transmitting a notification may be based on the notification history. For example, the notification history may indicate that a previous notification has been transmitted based on the triggering event, and step 614 may include scheduling a delay in transmitting a notification until a later time.

In some embodiments, transmitting (i.e., sending) the notification may include sending a command to a user device and/or account system 106 to provide a notification based on a notification condition. For example, the notification condition may include an instruction to display or play a notification when activity-data and/or account-engagement data satisfy a criterion (e.g., at a specified time, following a login, and/or when a user device is near a location). The notification condition may be generated by the user event-model (e.g., during step 610).

At step 616, monitoring system 104 may receive a user command, consistent with disclosed embodiments. In some embodiments, monitoring system 104 may receive a user command from user device 102 and/or account system 106. For example, monitoring system 104 may receive a user command from account system 106 that was previously received by account system 106 from a user device. In some embodiments, a user command may include an instruction to create or update an account rule. In some embodiments, user command data is received in the notification of step 614.

At step 618, monitoring system 104 may receive additional data, including account data, account-engagement data, and/or activity data, consistent with disclosed embodiments. In some embodiments, the additional data may relate to the notification of step 614. For example, monitoring system 104 may receive additional account-engagement data that relates to the notification such as data indicating whether user device 102 displayed the notification, data indicating whether a user performed an account action following receipt of the notification, etc.

At step 620, monitoring system 104 may update a user event-model based on the additional data, consistent with disclosed embodiments. In some embodiments, updating a user event-model may include training the user event-model (e.g., by implementing process 500 and training a user event-model using the additional data).

At step 622, monitoring system 104 may update a user profile based on a user command, consistent with disclosed embodiments. Updating a user profile may include updating an account rule based on a user command (e.g., the user command of step 616).

As one of skill in the art will appreciate, steps 602 to 622 may be repeated one or more times. For example, monitoring system 104 may receive continuously or repeatedly receive account data and/or activity data and perform steps of process 600.

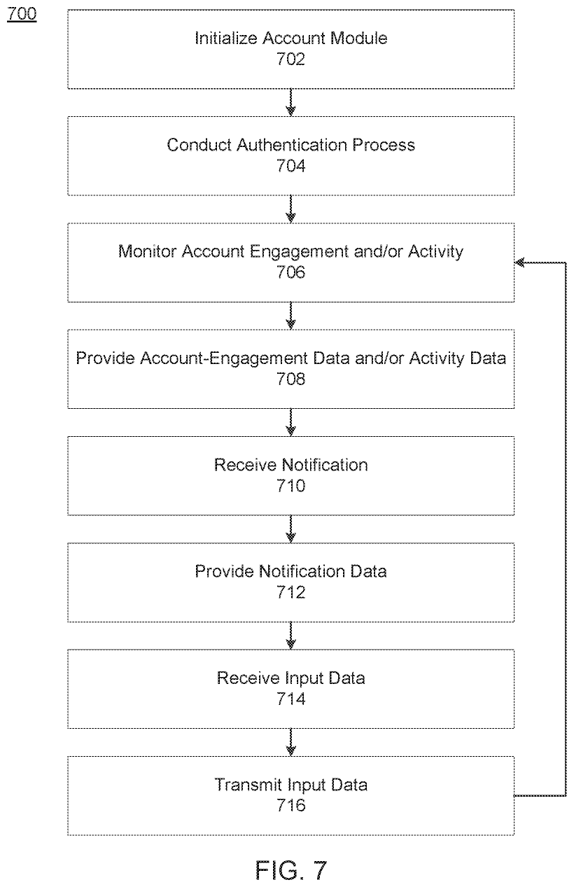

FIG. 7 depicts exemplary process 700 for engaging an account monitoring system, consistent with disclosed embodiments. In some embodiments, a user device (e.g., user device 102) may perform steps of process 700, consistent with disclosed embodiments. In some embodiments, account system 106 may perform steps of process 700.

At step 702, user device 102 may initialize an account monitor, consistent with disclosed embodiments. Initializing an account monitor may include installing, configuring, and/or opening an application. In some embodiments, initializing an account monitor may include providing user profile data (e.g., data related to a user and/or an account rule).

At step 704, user device 102 may conduct an authentication process, consistent with disclosed embodiments. In some embodiments, the authentication process may include receiving authentication data via an input device (e.g., microphone 331, input device 333, display 324, and/or sensor 327). In some embodiments, the authentication process may include authenticating the user locally on the device (e.g., confirming a pin or passcode). In some embodiments, the authentication process may include transmitting authentication data to a remote computing component (e.g., to monitoring system 104 and/or account system 106). In some embodiments, the authentication process may include receiving authentication data (e.g., verification data) from a remote computing component (e.g., to account monitor 104 and/or account system 106).

At step 706, user device 102 may monitor account engagement and/or activity, consistent with disclosed embodiments. In some embodiments, monitoring account engagement may include collecting account-engagement data, including any account-engagement data as previously described and/or any other account-engagement data. In some embodiments, monitoring activity may include collecting activity data, including any activity data as previously described and/or any other activity data.

At step 708, user device 102 may provide account-engagement data and/or activity data, consistent with disclosed embodiments. Providing account-engagement data and/or activity data may include transmitting data to monitoring system 104 and/or account system 106.

At step 710, user device 102 may receive a notification, consistent with disclosed embodiments. In some embodiments, receiving a notification includes receiving the notification from monitoring system 104 and/or account system 106.

At step 712, user device 102 may provide notification data based on the notification, consistent with disclosed embodiments. In some embodiments, providing notification data may include storing data in data 331, displaying data via display 324, playing an audio signal via speaker 322, and/or providing haptic feedback via haptic device 326. In some embodiments, providing notification data may include providing a prompt (e.g., a request for user input) via a speaker and/or a display.

At step 714, user device 102 may receive input data, consistent with disclosed embodiments. In some embodiments, the input data may include account-engagement data. In some embodiments, the input data may include a user command such as an instruction to create or update an account rule.

At step 716, user device 102 may transmit input data, consistent with disclosed embodiments. In some embodiments, transmitting input data may include transmitting data to monitoring system 104 and/or account system 106.

As shown in FIG. 7, steps 706 to 716 may be repeated one or more times. For example, monitoring system 104 may receive continuously or repeatedly monitor account engagement and/or activity.

### Exemplary Embodiment

In an exemplary embodiment, monitoring system 104 may implement steps of process 400 to train a reference event-model to identify a triggering event based on reference data associated with a plurality of users (i.e., reference account-engagement data, reference account-data, and/or reference activity-data). Reference data may comprise data for thousands, millions, or even more of deposits and account-engagement actions. Accordingly, in the embodiment, monitoring system 104 may train a reference event-model to accurately identify triggering events based on underlying interests of users (e.g., to anticipate a user's interest and transmit a notification before the user engages an account to obtain information).

In the exemplary embodiment, reference account-data may include the posting of deposits to a plurality of financial accounts (i.e., deposit data). Deposit data may have descriptive and/or statistical features. For example, the amount of some deposits may be more than two standard deviations from a mean deposit of their respective accounts (i.e., unusually large deposits). Some deposits of similar or identical amounts may arrive at regular time intervals (e.g., monthly pay), while some deposits of widely varying amounts may arrive at irregular time intervals (e.g., bonus pay). A plurality of deposits may originate with the same outside account (e.g., transfers from another account held by the user), while other deposits may originate with respective unique accounts (e.g., one-time payments from clients under different consulting contracts).

To further illustrate the exemplary embodiment, reference account-engagement data may include data collected on mobile devices associated with the respective financial accounts (e.g., data collected via a mobile banking app). These data may include the time of balance checks and the location data related to the balance checks. Accordingly, account-engagement data may reflect an underlying interest in the account (e.g., a user may believe that a deposit will post and check the account several times each day until the deposit posts). Reference account-engagement data may have descriptive and/or statistical features, and reference account-engagement data may have statistical relationships with reference deposit data. For example, balance inquiries may occur with high frequency (e.g., multiple times per day) prior to the posting of some deposits but occur with low frequencies (e.g., once per week) prior to the posting of other deposits. Balance inquiries preceding some deposits may more often occur at a residence than at a place of business. As another example, balance inquiries preceding some deposits may occur most often within a range of time (e.g., between 7:00 am and 8:00 am and 6:00 pm to 8:00 pm, but not between 8:00 am and 6:00 pm).

Still referring to the exemplary embodiment, monitoring system 104 may train a reference event-model to identify one or more triggering events based on a correlation between the deposit data (e.g., deposit amounts, deposit regularities, deposit origins) and the account-engagement data (e.g., the timing and location of balance inquiries). For example, a triggering event instance may include data indicating (i) a deposit over a certain amount has posted, (ii) a user device is located at a residence, and (iii) a time of day is between 7:00 am and 8:00 am. As another example, a triggering event instance may include data indicating (i) a deposit originating from a unique account has posted and (ii) a time of day is between 9:00 am and 5:00 pm. As one of skill in the art will appreciate, other examples of triggering events are possible. Further, as previously described, a triggering event may be based on non-deterministic response, and the reference event-model may be trained to identify triggering events without applying a human-understandable, logical rule.

To continue illustrating the exemplary embodiment, monitoring system 104 may optimize the reference event-model by generating a user event-model to identify triggering events for a particular user and/or account. That is, monitoring system 104 may implement steps of process 500 to generate a user event-model based on the reference model and train the user event-model to identify triggering events using user data associated with an account (i.e., user account-data, user activity-data, and/or user account-engagement data). Often, user data may be sparse and comprise few deposits and/or account-engagement actions (e.g., tens of deposits). Advantageously, in the exemplary embodiment, monitoring system 104 may begin training a user event-model when the event-model is in a state that matches the reference model, which may accurately identify triggering events for many users, and monitoring system 104 may customize the user event-model using sparse user data.

In the exemplary embodiment, monitoring system 104 may receive user data comprising deposit data and user account-engagement data associated with a financial account. Monitoring system 104 may train a user event-model to identify triggering events that are customized to the user. For example, as compared to the reference event-model, the user event-model may be trained to identify triggers at different locations, times of days, for different deposit amounts, etc., which relate to a user data. Consistent with disclosed embodiments, identifying a triggering event may be based on an account rule (e.g., a user preference to receive notifications when an app is opened on a user device).

The exemplary embodiment is provided for purposes of illustration and is not limiting on the disclosed embodiments. As one of skill in the art will appreciate, event models may be trained to identify other triggering events associated with financial accounts or other types accounts. For example, an event model may be trained to identify a triggering event based on data indicating that a user may be likely to perform an account action related to a triggering event after receiving the notification (e.g., respond to an email, place an order, request a prescription refill, transfer funds, etc.).

It should be noted that account system 106 may be configured to perform any of the steps described in reference to monitoring system 104 and/or user device 102 including, for example, steps of processes 400, 500, 600, and 700. In some embodiments, monitoring system 104 may provide a model to account system 106, and account system 106 may train and/or implement the model to generate and provide navigation menus. In some embodiments, account system 106 may be configured to train and implement a model to identify a triggering event and/or to provide a notification based on a triggering event.

Systems and methods disclosed herein involve unconventional improvements over conventional account monitoring approaches. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone.

Computer programs based on the written description and methods of this specification are within the skill of a software developer. The various functions, scripts, programs, or modules can be created using a variety of programming techniques. For example, programs, scripts, functions, program sections or program modules can be designed in or by means of languages, including JAVASCRIPT, C, C++, JAVA, PHP, PYTHON, RUBY, PERL, BASH, or other programming or scripting languages. One or more of such software sections or modules can be integrated into a computer system, non-transitory computer-readable media, or existing communications software. The programs, modules, or code can also be implemented or replicated as firmware or circuit logic.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

1. A system for monitoring accounts, comprising:
one or more memory units storing instructions; and
one or more processors that execute the instructions to perform operations comprising:
receiving a reference model configured to identify a first triggering event based on a correlation between account-engagement data associated with a plurality of accounts and account data associated with the accounts:
receiving user account data associated with one of the accounts of a user;
receiving first account-engagement data associated with the user account, the first account-engagement data comprising data related to an action performed by the user on a user device, the action being associated with the user account;
generating a user event model based on the reference model:
based on receiving the first account-engagement data, training the user event model to identify a triggering event based on a correlation between the user account data and the first account-engagement data, wherein the training comprises applying a forward and backward propagation technique while adjusting model parameters until a training criterion is satisfied, wherein the training generates a logical expression that specifies to transmit a notification to the user device when second account-engagement data satisfies the triggering event;
identifying, using the generated logical expression, an instance of second account-engagement data satisfying the triggering event; and
transmitting, to the user device, a notification related to the account based on the identified instance.

2. The system of claim 1, wherein the account data comprises at least one of upload data, download data, file size data, transaction data, order data, message data, view data, cross-reference data, or social media data.

3. The system of claim 1, wherein:
the first and second account-engagement data comprise at least one of location data, call data, screen time data, query data, refresh data, or login data; and
identifying the triggering event instance is based on at least one of location data, call data, screen time data, query data, refresh data, or login data.

4. The system of claim 1, wherein:
the operations further comprise:
receiving reference account-data;
receiving reference account-engagement data; and
training the reference model based on the reference account-data and the reference account-engagement data.

5. The system of claim 4, the operations further comprising storing the reference event model in a data storage.

6. The system of claim 1, wherein sending the notification is based on at least one of a time, a login, a setting of the account, or a location of a device associated with the account.

7. The system of claim 1, wherein the user event model comprises at least one of a neural network model, a recurrent neural network model, a random forest model, or a support vector machine model.

8. The system of claim 1, wherein:
the operations further comprise:
receiving first activity data associated with the account; and
receiving second activity data associated with the account;
training the user event model is based on the first activity data; and
identifying the triggering event instance is based on the second activity data.

9. The system of claim 8, wherein at least one of the first or second activity data comprises at least one of location data, purchase data, order data, reservation data, search term data, website-visit data, media data, download data, upload data, social media data, message data, or call data.

10. The system of claim 8, wherein receiving first activity data comprises receiving activity data from at least one of a user device or a third-party system.

11. The system of claim 8, wherein receiving second activity data comprises receiving second activity data from at least one of a device associated with the account or a third-party system.

12. The system of claim 8, wherein:
the operations further comprise:
receiving reference account data;
receiving reference activity-data;
receiving reference account-engagement data; and
training the reference event model based on the reference account-data, the training-activity data, and the reference account-engagement data;

13. The system of claim 12, wherein the reference activity-data comprises at least one of location data, purchase data, order data, reservation data, search term data, website-visit data, media data, download data, upload data, social media data, message data, or call data.

14. The system of claim 1, wherein transmitting a notification comprises transmitting a notification to a device associated with the account.

15. The system of claim 1, the operations further comprising storing the user event model in a data storage.

16. The system of claim 1, wherein the account comprises one of a user account, a financial account, a messaging-service account, a social media account, a membership account, or a shopping account.

17. The system of claim 1, wherein the triggering event instance comprises a deposit to a financial account.

18. The system of claim 1, wherein the triggering event instance is identified based on receiving additional account data at a cloud service.

19. A method for monitoring accounts comprising the following operations performed by one or more servers:
receiving a reference model configured to identify a first triggering event based on a correlation between account-engagement data associated with a plurality of accounts and account data associated with the accounts;
receiving user account data associated with one of the accounts of a user;
receiving first account-engagement data associated with the user account, the account-engagement comprising data associated with the account, the first account engagement data comprising data related to an action performed by the user on a user device, the action being associated with the user account;
generating a user event model based on the reference model;
based on receiving the first account-engagement data, training the user event model based on a correlation between the user account data and the first account-engagement data, wherein the training comprises applying a forward and backward propagation technique while adjusting model parameters until a training criterion is satisfied, wherein the training generates a logical expression that specifies to transmit a notification to the user device when second account-engagement data satisfies the triggering event;
identifying, using the generated logical expression, an instance of second account-engagement data satisfying the triggering event; and
transmitting, to the user device, a notification related to the account based on the identified instance.

20. A system for monitoring accounts, comprising:
one or more memory units storing instructions; and
one or more processors that execute the instructions to perform operations comprising:
receiving reference account-data;
receiving reference account-engagement data;
training a reference event model based on the reference account-data and the reference account-engagement data;
receiving user account data associated with an account of a user;
receiving first account-engagement data associated with the user account, the first account engagement data comprising data related to an action performed by a user on a user device, the action being associated with the user account;
generating a user event model based on the reference event model;
based on receiving the first account-engagement data, training the user event model to identify a triggering event based on a correlation between the user account data and the first account-engagement data, wherein the training comprises applying a forward and backward propagation technique while adjusting model parameters until a training criterion is satisfied, wherein the training generates a logical expression that specifies to transmit a notification to the user device when second account-engagement data satisfies the triggering event;
identifying, using the generated logical expression, an instance of second account-engagement data satisfying the triggering event; and
transmitting, to the user device, a notification related to the account to a device associated with the account based on the identified instance.
